(19) United States
(12) Patent Application Publication
(10) Pub. No.: US 2015/0104625 A1
(43) Pub. Date: Apr. 16, 2015

(54) ELECTROCONDUCTIVE COMPOSITION

(71) Applicant: TAIYO INK MFG. CO., LTD., Hiki-gun (JP)

(72) Inventor: Naoyuki Shiozawa, Sakado-shi (JP)

(73) Assignee: TAIYO INK MFG. CO., LTD., Hiki-gun (JP)

(21) Appl. No.: 14/397,276

(22) PCT Filed: Apr. 25, 2013
(86) PCT No.: PCT/JP2013/062294

§ 371 Date: Oct. 27, 2014

(30) Foreign Application Priority Data
Apr. 27, 2012 (JP) 2012-102170

(51) Int. Cl. C09D 5/24; H01B 13/30; H01B 1/22

(52) U.S. Cl. CPC C09D 5/24; H01B 1/22; H01B 13/30
USPC 428/208; 252/514; 427/125

(57) ABSTRACT

Provided is an electroconductive composition which not only shows excellent adhesion to a substrate and can easily form a smooth film, but also is applicable to the formation of a fine-pitched circuit and the like and capable of providing high electroconductivity even when dried at a relatively low temperature. The electroconductive composition comprises (A) a crystalline flake silver powder and (B) an organic binder, wherein the blending ratio of the (A) crystalline flake silver powder is 90% by mass to 98% by mass with respect the total solid content of the composition. In a preferred embodiment, the (A) crystalline flake silver powder contains polygonal single particles and has an average particle size (D₅₀), which is determined by a laser diffraction-scattering particle size distribution analysis, of 1 μm to 3 μm.

### TECHNICAL FIELD

The present invention relates to an electroconductive composition. More particularly, the present invention relates to an electroconductive composition that is useful for forming, for example, a conductor pattern circuit of a printed wiring board, especially a flexible printed wiring board, and a conductor pattern circuit on a front substrate or back substrate of a plasma display panel.

### BACKGROUND ART

Conventionally, thermosetting electroconductive compositions have been widely used for forming electrodes of resistive film-type touch panels, patterned circuits of printed wiring boards and the like by being coated or printed and subsequently heat-cured on a film substrate, a glass substrate or the like. Further, in the formation of a conductor pattern circuit on a plasma display panel, fluorescent display tube, electronic component or the like, pattern formation has been generally carried out by a screen printing method using an electroconductive composition containing a large amount of metal powder and/or glass powder. In recent years, as resin substrates and thermally weak parts are more often used due to product down-sizing, there is a demand for a low-resistance electroconductive material that is cured at a low temperature.

Electroconductive compositions in which an electroconductive material such as metal particles of silver or the like is dispersed in a resin or the like have been widely used in the formation of an electric circuit and the like (see, for example, Patent Documents 1 to 3) and, as a method of forming a conductor circuit using such an electroconductive composition, there is known, for example, a method in which an electroconductive composition is printed or coated on a substrate to form a pattern and the thus formed pattern is subsequently dried. Incidentally, in recent years, as the wiring width, wiring film thickness and the like of circuits have been considerably reduced, it is increasingly demanded not only to reduce the electrical resistance of conductors formed using an electroconductive composition, but also to attain high connection reliability. However, in conventional electroconductive compositions, electroconductivity is provided by contact between powder particles; therefore, high connection reliability cannot be attained when a fine wiring is formed at a low temperature. Accordingly, there is an increasing demand for a silver composition whose silver powder particles are sintered with each other at a low temperature to exert electroconductivity. Generally speaking, in order to meet such a demand, it is considered to lower the sintering temperature by making silver powder, which is an electroconductive filler, into fine particles.

Further, in the above-described method of forming a conductor circuit, a resin film is used as a substrate in some cases. However, since resin films generally have a low heat resistance, there is a demand for an electroconductive composition which can be dried at a low-temperature and has a low electrical resistance. In order to meet this demand, Patent Document 2 proposes a resin-free electroconductive composition. This electroconductive composition can form a low-specific-resistance conductor circuit even when it is dried at a low temperature of about 150° C.; however, since this composition does not contain any resin, not only the adhesion thereof may be weak depending on the substrate type and detachment from the substrate may occur, but also formation of a smooth film is difficult.

Meanwhile, Patent Document 3 proposes an electroconductive composition which comprises a flake-form special silver powder of 130 nm or less in thickness and a binder containing a halogen-containing organic resin. This electroconductive composition can form a conductor circuit having a low specific resistance; however, there is a problem of high cost due to the use of the special silver powder. Furthermore, for processing of silver powder into flake-form silver powder, a method of flaking silver powder with a physical force using a grinding medium-containing ball mill, vibration mill, stirring-type pulverizer or the like has been employed; however, it is difficult to control the particle size of the resulting flake-form silver powder due to, for example, generation of agglomerated powder.

### RELATED ART DOCUMENTS

### Patent Documents

Patent Document 1: Japanese Unexamined Patent Application Publication No. H9-306240

Patent Document 2: Japanese Unexamined Patent Application Publication No. 2003-203522

Patent Document 3: Japanese Patent No. 4573089

### SUMMARY OF THE INVENTION

### Problems to be Solved by the Invention

As described above, in conventional silver paste technology, preparation of fine particles of silver powder and the use of a flake-form special powder have been examined.

Still, it is generally considered difficult to satisfy both size reduction and dispersibility in the particles of metal powder such as silver powder. For instance, in the case of a silver paste containing silver nanoparticles, in order to stabilize the dispersion of the silver nanoparticles, a relatively large amount of a dispersant is generally added as a protective colloid. In such a case, the decomposition temperature of the dispersant is normally higher than the sintering temperature of the silver nanoparticles and this causes residual dispersant between the silver nanoparticles. Here, since the silver nanoparticles are remarkably small in size, it is difficult to secure contact between the particles and their intrinsic low-temperature sintering characteristics are thus highly unlikely to be utilized sufficiently. Furthermore, in the case of a silver paste containing silver nanoparticles, since its content of silver powder is largely lower than those of conventional pastes, even though a thin film can be easily formed, it is difficult to form a thick film. Even if a thick film can be formed, the resulting film has a remarkably high specific resistance; therefore, it is difficult to apply the film to an application of forming such a wiring circuit having a large circuit cross-section that can be used in a power supply circuit charged with a relatively large electric current or to a low-resistance circuit application. Moreover, in an application of an adhesive for mounting components, in addition to the electroconductivity requirement, the requirement for adhesive strength is also stringent, and it is thus indispensable to add a resin which exhibits a high adhesive strength when cured in a certain amount or more; therefore, there are many aspects that cannot be answered with a silver particle containing silver nanoparticles.

Meanwhile, a flake silver powder is produced by physically subjecting silver powder particles to plastic working and subsequent crushing, and such a flake silver powder is sometimes referred to as “scaly silver powder”. Certainly, as easily expected from its shape, a flake silver powder is capable of securing large contact areas between its powder particles and, therefore, useful for lowering the resistance of a conductor to be formed. However, since a silver powder obtained by a conventional production method contains coarse particles having a size of larger than 10 μm, it is at present not possible to apply such a silver powder to the formation of a fine-pitched pattern or the like of recent years. In addition, in the production of a flake silver powder by physical application of plastic deformation to such a silver powder, there is a problem that the variation among the powder particles contained in the original silver powder is exacerbated and only a flake silver powder having deteriorated powder characteristics can thus be obtained.

The present invention was made in view of the above-described problems in the prior art, and an object of the present invention is basically to provide an electroconductive composition which not only shows excellent adhesion to a substrate and can easily form a smooth film, but also is applicable to the formation of a fine-pitched circuit and the like and is capable of providing high electroconductivity even when dried at a relatively low temperature.

### Means for Solving the Problems

In order to achieve the above-described object, the present invention provides an electroconductive composition comprising a crystalline flake silver powder and an organic binder, wherein the crystalline flake silver powder is blended at a ratio of 90% by mass to 98% by mass with respect to the total solid content of the composition.

In a preferred embodiment, the above-described crystalline flake silver powder contains polygonal single particles, and it is preferred that the crystalline flake silver powder have an average particle size (D₅₀), which is determined by a laser diffraction-scattering particle size distribution analysis, of 1 μm to 3 μm.

Further, the present invention also provides a cured article obtained by printing or coating the above-described electroconductive composition of the present invention on a substrate to form a coating film pattern and subsequently drying the coating film pattern at a temperature of lower than 150° C.

### Effects of the Invention

Since the flake silver powder contained in the electroconductive composition of the present invention as an electroconductive filler is crystalline, a fine flake silver powder can be produced with a relatively narrow size distribution and excellent dispersibility. Also, since the flake silver powder is in the form of single crystals, it has a high electroconductivity and low-melting-point characteristics. Accordingly, the electroconductive composition of the present invention, which comprises such a crystalline flake silver powder at a high ratio of 90% by mass to 98% by mass with respect to the total solid content of the composition, not only shows excellent adhesion to a substrate and can easily form a smooth film but also can be printed with high resolution and provide a high electroconductivity even when dried at a relatively low temperature; therefore, the electroconductive composition of the present invention is applicable to the formation of a fine-pitched circuit and the like.

### BRIEF DESCRIPTION OF THE DRAWINGS

FIG. 1 is a scanning electron micrograph (magnification: ×7,000) of a crystalline flake silver powder (M13, manufactured by Tokusen Kogyo Co., Ltd.).

FIG. 2 is a scanning electron micrograph (magnification: ×8,000) of a crystalline flake silver powder (M13, manufactured by Tokusen Kogyo Co., Ltd.).

FIG. 3 is a scanning electron micrograph (magnification: ×7,000) of a crystalline flake silver powder (M27, manufactured by Tokusen Kogyo Co., Ltd.).

FIG. 4 is a scanning electron micrograph (magnification: ×10,000) of a crystalline flake silver powder (M27, manufactured by Tokusen Kogyo Co., Ltd.).

FIG. 5 is a scanning electron micrograph (magnification: ×7,000) of a crystalline flake silver powder (M612, manufactured by Tokusen Kogyo Co., Ltd.).

FIG. 6 is a scanning electron micrograph (magnification: ×8,000) of a crystalline flake silver powder (M612, manufactured by Tokusen Kogyo Co., Ltd.).

FIG. 7 is a scanning electron micrograph (magnification: ×5,000) of a flake silver powder produced by flaking with a conventional physical force.

FIG. 8 is a scanning electron micrograph (magnification: ×7,000) of a flake silver powder produced by flaking with a conventional physical force.

### MODE FOR CARRYING OUT THE INVENTION

According to the studies conducted by the present inventor, it was discovered that, since the crystalline flake silver powder used in the present invention is made into a flake form not by a physical force but by crystallization, it not only has a uniform particle size and thickness as well as excellent dispersibility and smooth film-forming properties, but also shows a high electroconductivity and low-melting-point characteristics; and that, by using this crystalline flake silver powder in an electroconductive resin composition, it is made possible to print the composition with high resolution and a reduction in resistance can be achieved in the resulting coating film, thereby the present invention was completed.

The constituents of the electroconductive composition of the present invention will now each be described.

The silver powder used in the electroconductive composition of the present invention is composed of single crystals and in the form of flakes. The phrase “in the form of flakes” used herein refers to a condition in which the value (aspect ratio) obtained by dividing the average particle size (D₅₀), which is determined by a laser light scattering method, by the average thickness determined by the below-described electron microscopy is not less than 2, preferably not less than 10, more preferably not less than 20. Here, the “D₅₀” refers to the particle size at 50% volume accumulation, which is determined by a laser diffraction-scattering particle size distribution analysis based on the Mie-scattering theory. More specifically, using a laser diffraction/scattering-type particle size distribution analyzer, the particle size distribution of electroconductive particles can be prepared based on volume and the median diameter can be measured as average particle size. As a measurement sample, a sample in which electroconductive particles are dispersed in water by ultrasonication can be preferably used. As the laser diffraction/scattering-type particle size distribution analyzer, for example, LA-500 manufactured by HORIBA Ltd. can be used. As for the average thickness, the silver particles are photographed under a scanning electron microscope and their thicknesses are measured and represented as an average of 50 measurements. It is preferred that the particles of the crystalline flake silver powder have a polygonal shape when observed from the front under a scanning electron microscope and a thin-plate shape when observed from the side, because this increases the contact area between the particles. The term “polygonal shape” used herein refers to a figure bounded by lines drawn between two points and endpoints thereof. As for the particle size, it is preferred that the average particle size (D₅₀), which is determined by a laser diffraction-scattering particle size distribution analysis, be 1 μm to 3 μm. A solvent dispersion-type silver powder in which the crystalline flake silver powder is substituted with a solvent suitable for a paste composition without being dried in its production process and the silver powder content is 90% by mass to 95% by mass is more preferred because it also shows good dispersibility and does not require an excessive surface treatment agent.

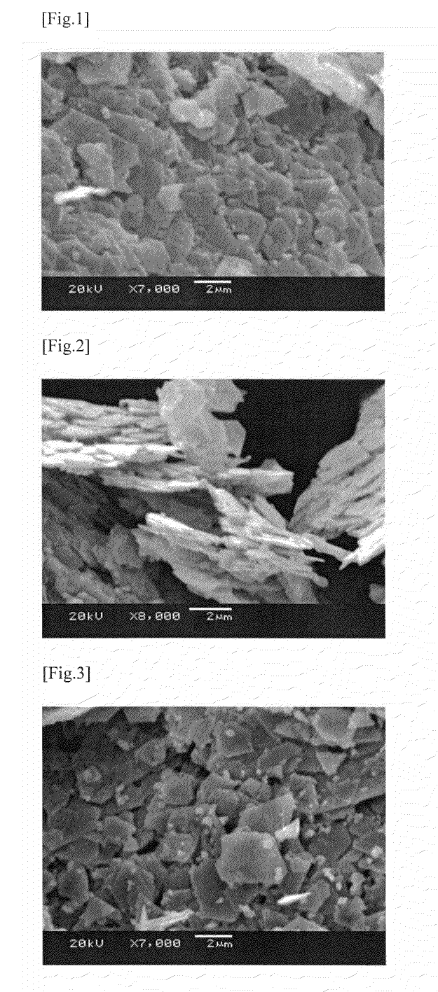

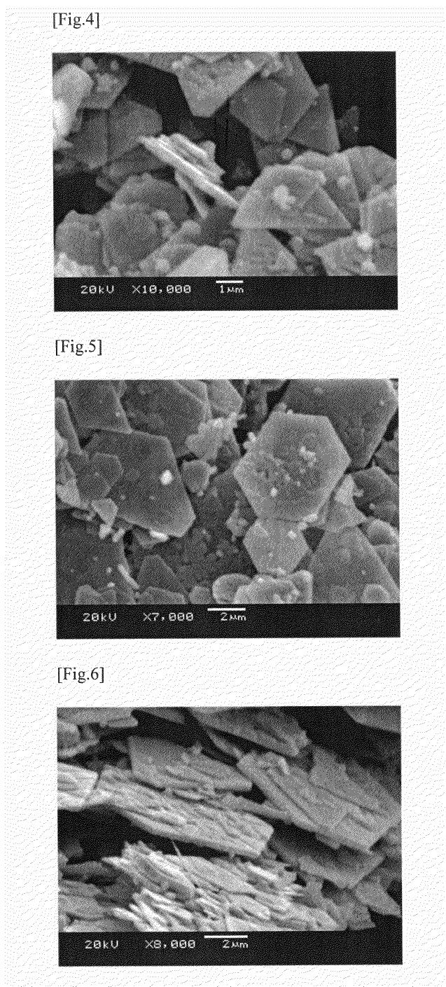

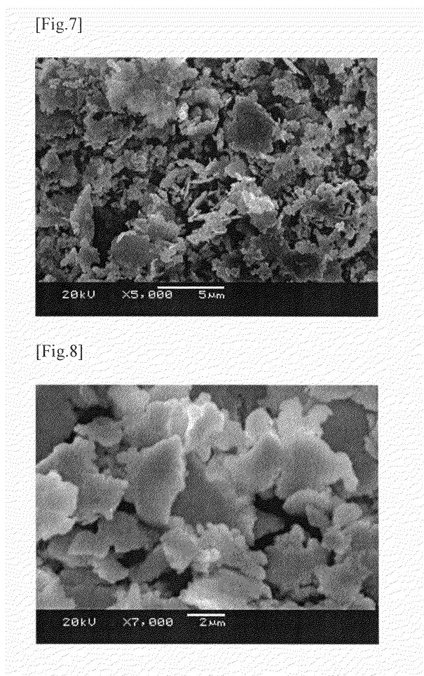

Specific examples of the crystalline flake silver powder that can be used in the present invention include M13 (particle size distribution: 1 μm to 3 μm), M27 (particle size distribution: 2 μm to 7 μm), M612 (particle size distribution: 6 μm to 12 μm), all of which are manufactured by Tokusen Kogyo Co., Ltd. and the like. FIGS. 1 to 6 show scanning electron micrographs of these crystalline flake silver powders. In addition, for reference, scanning electron micrographs of a flake silver powder produced by flaking with a conventional physical force are shown in FIGS. 7 and 8. As apparent from the scanning electron micrographs shown in FIGS. 1 to 6, the crystalline flake silver powders M13, M27 and M612 have a thickness of 40 nm to 60 nm, about 100 nm and about 200 nm, respectively, and they are in the form of flat polygonal flakes with uniform thickness and show high electroconductivity. Particularly, M13 is preferred since it has a particle size distribution of 1 μm to 3 μm and an average particle size (D₅₀) of 2 μm to 3 μm or so and is thus capable of forming a smooth and low-specific-resistance electroconductive film that is densely filled with fine particles. Further, although M27 has an average particle size (D₅₀) of 3 μm to 5 μm or so and M612 has an average particle size (D₅₀) of 6 μm to 8 μm or so, since these crystalline flake silver powders contain polygonal single particles, even with the relatively large average particle sizes (D₅₀) or relatively wide particle size distributions, they are capable of forming a smooth film densely filled with fine particles, hence a low-resistance electroconductive film. In contrast, as shown in FIGS. 7 and 8, it cannot be said that a flake silver powder produced by flaking with a conventional physical force is in the form of flat flakes having uniform thickness and, in such a flake silver powder, the variation among the powder particles contained in the original silver powder is exacerbated and the powder characteristics are deteriorated, making it difficult to apply the flake silver powder to the formation of a fine-pitched pattern or the like of recent years.

It is appropriate that the blending ratio of the above-described crystalline flake silver powder be 90% by mass to 98% by mass, preferably 93% by mass to 97% by mass, with respect to the total solid content of the composition. When the blending ratio of the crystalline flake silver powder is less than 90% by mass, the resulting electroconductive film is likely to have a high specific resistance, while when the crystalline flake silver powder is blended in a large amount that exceeds 98% by mass, it is difficult to produce a stable and favorable composition and the adhesion to a substrate is weakened; therefore, such blending ratios are not preferred.

The above-described organic binder is used for the purposes of, for example, producing a stable and favorable composition, forming a smooth film, and imparting the resulting electroconductive film with adhesiveness to a substrate, flexibility and the like. As the organic binder, a thermosetting or dry-type organic binder can be used. Examples of the thermosetting organic binder include polyester resins (e.g., modified urethane, modified epoxy and modified acrylic resins), epoxy resins, urethane resins, phenol resins, melamine resins, vinyl-based resins and silicone resins, which are capable of increasing the molecular weight by a curing reaction and forming a film by cross-link formation. Examples of the dry-type organic binder include polyester resins, acrylic resins, butyral resins, vinyl chloride-vinyl acetate copolymer resins, polyamide imide, polyamide, polyvinyl chloride, nitrocellulose, cellulose-acetate-butyrate (CAB) and cellulose-acetate-propionate (CAP), which are soluble to a solvent and capable of forming a film when dried, and these dry-type organic binders can be cured at a low temperature depending on the solvent selection. These organic binders may be used individually, or two or more thereof may be used in combination. Thereamong, those dry-type organic binders that are capable of forming a pattern having a low resistance and excellent adhesiveness at a low temperature of not higher than 150° C. are preferred.

These organic binders have a number-average molecular weight of not less than 3,000, preferably not less than 10,000, and the upper limit thereof is not restricted. However, considering the resin solubility, the number-average molecular weight is preferably 200,000 or less.

It is appropriate that the blending ratio of the organic binder(s) (in terms of solid content ratio) be 2% by mass to 10% by mass, preferably 3% by mass to 7% by mass, with respect to the total amount of the composition.

In the electroconductive composition of the present invention, a small amount of an adduct of an epoxy compound and an imidazole compound may also be incorporated at a ratio of for example, 1% by mass or less, preferably 0.5% by mass or less, with respect to the total amount of the composition. The adduct of an epoxy compound and an imidazole compound not only exerts an effect of improving the adhesion of the resulting electroconductive film to a substrate, but also acts as a curing agent when the above-described organic binder is a thermosetting resin such as an epoxy resin. The epoxy compound used for forming such an adduct may be a monoepoxy compound or a polyepoxy compound. Examples of the monoepoxy compound include butyl glycidyl ether, hexyl glycidyl ether, phenyl glycidyl ether, p-xylyl glycidyl ether, glycidyl acetate, glycidyl butyrate, glycidyl hexoate and glycidyl benzoate, and examples of the polyepoxy compound include bisphenol A-glycidyl ether type epoxy resins and phenol novolac-glycidyl ether type epoxy resins. These epoxy compounds may be used individually, or two or more thereof may be used in combination. Meanwhile, examples of the imidazole compound used for forming such an adduct include imidazoles and 2-substituted imidazoles, such as 2-methylimidazole, 2-ethylimidazole, 2-isopropylimidazole, 2-dodecylimidazole, 2-ethyl-4-methylimidazole and 2-phenylimidazole.

In the electroconductive composition of the present invention, as required, a solvent may also be used for dispersing the above-described silver powder. As the solvent, an organic solvent can be used. Specific examples of the organic solvent include ketones such as methyl ethyl ketone and cyclohexanone; aromatic hydrocarbons such as toluene, xylene and tetramethylbenzene; glycol ethers such as cellosolve, methyl cellosolve, carbitol, methyl carbitol, butyl carbitol, propylene glycol monomethyl ether, dipropylene glycol monomethyl ether, dipropylene glycol monoethyl ether and triethylene glycol monoethyl ether; acetates such as ethyl acetate, butyl acetate, cellosolve acetate, butyl cellosolve acetate, carbitol acetate, butyl carbitol acetate and propylene glycol monomethyl ether acetate; alcohols such as ethanol, propanol, ethylene glycol, propylene glycol and terpineol (α-terpineol); aliphatic hydrocarbons such as octane and decane; and petroleum solvents such as petroleum ether, petroleum naphtha, hydrogenated petroleum naphtha and solvent naphtha. These organic solvents may be used individually, or two or more thereof may be used in combination.

In cases where screen printing is employed, a high-boiling-point solvent is preferably used. As the high-boiling-point solvent, for example, ketone-based high-boiling-point solvents such as isophorone, cyclohexanone and γ-butyrolactone are preferred. In cases where the composition is coated using a disperser or the like, for example, a solvent which has a boiling point of preferably 60° C. to 180° C., more preferably 100° C. to 160° C., such as isobutyl acetate, isoamyl acetate or propylene glycol monomethyl ether acetate, is used. A solvent having a boiling point of 60° C. or lower is dried rapidly and thus likely to cause needle clogging, while a solvent having a boiling point of 180° C. or higher is dried slowly. The blending ratio of the organic solvent(s) is not particularly restricted as long as it is a quantitative ratio with which the viscosity of the electroconductive composition can be adjusted as appropriate; however, the blending ratio is desirably one which allows the electroconductive composition to have a viscosity of 50 dPa·s to 3,000 dPa·s, preferably 100 dPa·s to 2,000 dPa·s.

In the electroconductive composition of the present invention, as required, a variety of additives, such as an antioxidant, a stabilizer, a dispersant, an antifoaming agent, an antiblocking agent, a fine molten silica, a silane coupling agent, a thixotropic agent, a colorant and an electroconductive powder other than the above-described silver powder (e.g., carbon powder) may also be incorporated. These additives may be used individually, or two or more thereof may be used in combination.

One example of a method of producing the electroconductive composition is a method of kneading a resin component and the above-described silver powder with an organic solvent. As a kneading method, for example, a method using a stirring/mixing apparatus such as a roll mill can be employed.

The method of producing a conductor circuit using an electroconductive composition according to the present invention comprises: the pattern forming step where a coating film pattern is formed by printing or coating the above-described electroconductive composition on a substrate; and the heat treatment step where the thus formed coating film pattern is dried or calcinated. For the formation of a coating film pattern, for example, a masking method or a resist method can be employed.

In the pattern forming step, for example, a printing method or a dispensing method can be employed. Examples of the printing method include gravure printing, offset printing and screen printing and, for the formation of a fine circuit, screen printing is preferred. Further, as a method of coating a large area, gravure printing and offset printing are suitable. The dispensing method is a method of forming a pattern by extruding an amount of an electroconductive composition to be coated from a needle in a controlled manner, and this method is suitable for forming a pattern partially on a grounding wire or the like or for forming a pattern on a part having an irregular surface.

Depending on the substrate used, the heat treatment step may be, for example, a drying process performed at about 80 to 150° C. or a calcination process performed at about 150 to 200° C. The electroconductive composition of the present invention contains the above-described crystalline flake silver powder; therefore, even when a coating film pattern formed in the pattern forming step is dried at a low temperature of not higher than 150° C., a highly electroconductive conductor circuit having a low specific resistance of 1×10⁻⁵ Ω·cm or less can be obtained. In the drying process, the drying temperature is preferably about 90° C. to about 140° C., more preferably about 100° C. to about 130° C. The drying time is preferably about 15 minutes to about 90 minutes, more preferably about 30 minutes to about 75 minutes.

Examples of the substrate that can be used include, in addition to printed wiring boards and flexible printed wiring boards that have a circuit formed thereon in advance, copper-clad laminates of all grades (e.g., FR-4) that use a composite material such as a paper-phenol resin, paper-epoxy resin, glass fabric-epoxy resin, glass-polyimide, glass fabric/nonwoven fabric-epoxy resin, glass fabric/paper-epoxy resin, synthetic fiber-epoxy resin, fluorocarbon resin-polyethylene-polyphenylene ether or polyphenylene oxide-cyanate ester; sheets and films that are made of a plastic such as polyester (e.g., polyethylene terephthalate (PET), polybutyrene terephthalate or polyethylene naphthalate), polyimide, polyphenylene sulfide or polyamide; silicon substrates; epoxy substrates; polycarbonate substrates; acrylic substrates; phenolic substrates; glass substrates; ceramic substrates; wafer substrates and the like. The above-described electroconductive composition is capable of forming a highly electroconductive conductor circuit even when it is dried at a low temperature; therefore, the present invention exhibits a particularly high effect when a sheet, film or substrate made of a low-heat-resistance thermoplastic plastic is used as the substrate.

### Examples

The present invention will now be concretely described by way of examples and comparative examples; however, the present invention is not restricted to the following examples by any means. It is noted here that all “part(s)” below are by mass unless otherwise specified.

### <Preparation of Electroconductive Composition>

According to the blending ratios (mass ratios) shown in Tables 1 to 3, a crystalline flake silver powder and a 30% by mass carbitol acetate solution of polyester resin were measured in prescribed amounts and then stirred and dispersed using a 3 roll mill to obtain the respective electroconductive compositions of Examples 1 to 11 and Comparative Examples 1 to 4. For Examples 12 to 17, electroconductive compositions were prepared using an acrylic resin or a butyral resin in place of the 30% by mass carbitol acetate solution of polyester resin. For Examples 18 to 20, electroconductive compositions were prepared using an acrylic resin and a phenoxy resin in place of the 30% by mass carbitol acetate solution of polyester resin. For Examples 21 to 27, electroconductive compositions were prepared using a phenoxy resin and an epoxy-imidazole adduct of an epoxy resin in place of the 30% by mass carbitol acetate solution of polyester resin.

The thus obtained electroconductive compositions were each coated on a glass slide and a PET film and subsequently dry-cured at 120° C. for 30 minutes to form a coating film.

For each of the thus formed coating films, the adhesion and electroconductivity were evaluated by the methods described below. The results thereof are shown in Tables 4 to 6.

TABLE 1

| | | | | | | | | | | | | Comparative | | | |
|---|---|---|---|---|---|---|---|---|---|---|---|---|---|---|---|
| Composition | Example | | | | | | | | | | | Example | | | |
| (parts by mass) | 1 | 2 | 3 | 4 | 5 | 6 | 7 | 8 | 9 | 10 | 11 | 1 | 2 | 3 | 4 |

| | | | | | | | | | | | | | |
|---|---|---|---|---|---|---|---|---|---|---|---|---|---|
| Crystalline flake | D₅₀: 2 to 3 μm*¹ | 90 | 93 | 95 | 97 | 98 | | | | | | | 99 |
| silver powder | D₅₀: 3 to 5 μm*² | | | | | | 93 | 95 | 98 | | | | |
| | D₅₀: 6 to 8 μm*³ | | | | | | | | | 93 | 95 | 98 | |

| | | | | | | | | | | | | | | | |
|---|---|---|---|---|---|---|---|---|---|---|---|---|---|---|---|
| Flake silver powder | | | | | | | | | | | | 90 | 93 | 95 | |
| D₅₀: 2 to 3 μm*⁴ | | | | | | | | | | | | | | | |
| 30%-by-mass carbitol acetate solution | 33.3 | 23.3 | 16.7 | 10.0 | 6.7 | 23.3 | 16.7 | 6.7 | 23.3 | 16.7 | 6.7 | 33.3 | 23.3 | 16.7 | 3.3 |
| of polyester resin*⁵ | | | | | | | | | | | | | | | |
| 30%-by-mass carbitol acetate solution | | | | | | | | | | | | | | | |
| of acrylic resin *⁶ | | | | | | | | | | | | | | | |
| 30%-by-mass carbitol acetate solution | | | | | | | | | | | | | | | |
| of butyral resin*⁷ | | | | | | | | | | | | | | | |
| 30%-by-mass carbitol acetate solution | | | | | | | | | | | | | | | |
| of phenoxy resin*⁸ | | | | | | | | | | | | | | | |
| Epoxy resin*⁹ | | | | | | | | | | | | | | | |
| Epoxy-imidazole adduct*¹⁰ | | | | | | | | | | | | | | | |

Note
*¹M13, manufactured by Tokusen Kogyo Co., Ltd.
*²M27, manufactured by Tokusen Kogyo Co., Ltd.
*³M612, manufactured by Tokusen Kogyo Co., Ltd.
*⁴AgC239, manufactured by Fukuda Metal Foil & Powder Co., Ltd.
*⁵Mw = about 20,000
*⁶ Nanostrength M53, manufactured by Arkema K.K.
*⁷Mw = about 30,000
*⁸Mw = about 40,000
*⁹Bisphenol A-type liquid epoxy resin
*¹⁰P0505, manufactured by Shikoku Chemicals Corporation

TABLE 2

| Composition | | Example | | | | | | | | |
|---|---|---|---|---|---|---|---|---|---|---|
| (parts by mass) | | 12 | 13 | 14 | 15 | 16 | 17 | 18 | 19 | 20 |
| Crystalline flake silver | D₅₀: 2 to 3 μm*¹ | 93 | 95 | 97 | 93 | 95 | 97 | 95 | 95 | 95 |
| powder | D₅₀: 3 to 5 μm*² | | | | | | | | | |
| | D₅₀: 6 to 8 μm*³ | | | | | | | | | |

| | | | | | | | | | |
|---|---|---|---|---|---|---|---|---|---|
| Flake silver powder, D₅₀: 2 to 3 μm*⁴ | | | | | | | | | |
| 30%-by-mass carbitol acetate solution of polyester | | | | | | | | | |
| resin*⁵ | | | | | | | | | |
| 30%-by-mass carbitol acetate solution of acrylic | 23.3 | 16.7 | 10.0 | | | | 15.8 | 13.4 | 8.4 |
| resin *⁶ | | | | | | | | | |
| 30%-by-mass carbitol acetate solution of butyral | | | | 23.3 | 16.7 | 10.0 | | | |
| resin*⁷ | | | | | | | | | |
| 30%-by-mass carbitol acetate solution of phenoxy | | | | | | | 0.9 | 3.8 | 8.4 |
| resin*⁸ | | | | | | | | | |
| Epoxy resin*⁹ | | | | | | | | | |
| Epoxy-imidazole adduct*¹⁰ | | | | | | | | | |

Note
*¹M13, manufactured by Tokusen Kogyo Co., Ltd.
*²M27, manufactured by Tokusen Kogyo Co., Ltd.
*³M612, manufactured by Tokusen Kogyo Co., Ltd.
*⁴AgC239, manufactured by Fukuda Metal Foil & Powder Co., Ltd.
*⁵Mw = about 20,000
*⁶ Nanostrength M53, manufactured by Arkema K.K.
*⁷Mw = about 30,000
*⁸Mw = about 40,000
*⁹Bisphenol A-type liquid epoxy resin
*¹⁰P0505, manufactured by Shikoku Chemicals Corporation

TABLE 3

| Composition | | Example | | | | |
|---|---|---|---|---|---|---|
| (parts by mass) | | 21 | 22 | 23 | 24 | 25 |
| Crystalline flake silver powder | D₅₀: 2 to 3 μm*¹ | 95 | 95 | 95 | 95 | 95 |
| | D₅₀: 3 to 5 μm*² | | | | | |
| | D₅₀: 6 to 8 μm*³ | | | | | |

| | | | | | |
|---|---|---|---|---|---|
| Flake silver powder, D₅₀: 2 to 3 μm*⁴ | | | | | |
| 30%-by-mass carbitol acetate solution of polyester resin*⁵ | | | | | |
| 30%-by-mass carbitol acetate solution of acrylic resin *⁶ | | | | | |
| 30%-by-mass carbitol acetate solution of butyral resin*⁷ | | | | | |
| 30%-by-mass carbitol acetate solution of phenoxy resin*⁸ | 12 | 15 | 13.3 | 16 | 16.7 |
| Epoxy resin*⁹ | 1.1 | 0.4 | 0.8 | 0.16 | |
| Epoxy-imidazole adduct*¹⁰ | 0.3 | 0.1 | 0.2 | 0.04 | |

Note
*¹M13, manufactured by Tokusen Kogyo Co., Ltd.
*²M27, manufactured by Tokusen Kogyo Co., Ltd.
*³M612, manufactured by Tokusen Kogyo Co., Ltd.
*⁴AgC239, manufactured by Fukuda Metal Foil & Powder Co., Ltd.
*⁵Mw = about 20,000
*⁶ Nanostrength M53, manufactured by Arkema K.K.
*⁷Mw = about 30,000
*⁸Mw = about 40,000
*⁹Bisphenol A-type liquid epoxy resin
*¹⁰P0505, manufactured by Shikoku Chemicals Corporation

### <Adhesion>

The adhesion of each coating film formed on a PET film in the above was evaluated by performing a cross-cut Cellotape (registered trademark) peeling test in accordance with JIS K5600-5-6. The evaluation criteria were as follows.

o: The coating film was not peeled.

Δ: The coating film was partially peeled.

x: The coating film was peeled over the entire surface.

### <Specific Resistance>

The resistance of each coating film formed on a glass slide in the above was measured at both ends thereof by a four-terminal method. Also, the line width, line length and thickness were measured and the specific resistance (volume resistivity) was determined to evaluate the electroconductivity.

TABLE 4

| | Example | | | | | | | | | | |
|---|---|---|---|---|---|---|---|---|---|---|---|
| Property | 1 | 2 | 3 | 4 | 5 | 6 | 7 | 8 | 9 | 10 | 11 |
| Adhesion | ∘ | ∘ | ∘ | ∘ | Δ | ∘ | ∘ | Δ | ∘ | ∘ | Δ |
| Specific | 7.7 | 0.98 | 0.72 | 0.9 | 0.92 | 1.9 | 2.7 | 6.6 | 1.1 | 1.7 | 2.1 |
| resistance | | | | | | | | | | | |
| (×10⁻⁵ | | | | | | | | | | | |
| Ω · cm) | | | | | | | | | | | |

TABLE 5

Comparative Example

| Property | 1 | 2 | 3 | 4 |
|---|---|---|---|---|
| Adhesion | ∘ | ∘ | ∘ | x |
| Specific resistance | 3.0 | 2.7 | 3.4 | 1.5 |
| (×10⁻⁵ Ω · cm) | | | | |

TABLE 6

| | Example | | | | | | | | | | | | | |
|---|---|---|---|---|---|---|---|---|---|---|---|---|---|---|
| Property | 12 | 13 | 14 | 15 | 16 | 17 | 18 | 19 | 20 | 21 | 22 | 23 | 24 | 25 |
| Adhesion | ∘ | ∘ | ∘ | ∘ | ∘ | ∘ | ∘ | ∘ | ∘ | ∘ | ∘ | ∘ | ∘ | Δ |
| Specific | 0.99 | 0.59 | 0.75 | 1.0 | 0.89 | 0.98 | 4.6 | 0.62 | 0.60 | 1.1 | 0.49 | 0.78 | 0.63 | 0.7 |
| resistance | | | | | | | | | | | | | | |
| (×10⁻⁵ Ω · cm) | | | | | | | | | | | | | | |

As shown in Tables 4 to 6, the coating films of Examples 1 to 11 had an equivalent or higher specific resistance as compared to those of Comparative Examples 1 to 3. Thereamong, in Examples 1 to 5 and 12 to 25, the use of the crystalline flake silver powder having an average particle size (D₅₀) of 1 μm to 3 μm resulted in lower resistance as compared to Comparative Examples 1 to 3. Particularly, in Examples 2 to 5, 12 to 14, 16, 17, 19, 20 and 22 to 25 where the crystalline flake silver powder having an average particle size (D₅₀) of 1 μm to 3 μm was blended in an amount of 93% by mass to 98% by mass, low resistance values in the order of 10⁻⁶ were obtained, while the specific resistance values measured for Comparative Examples 1 to 3 were in the order of 10⁻⁵. Meanwhile, in Comparative Example 4 where the crystalline flake silver powder having an average particle size (D₅₀) of 1 μm to 3 μm was used but it was blended in an amount exceeding 98% by mass, which was 99% by mass, the coating film showed poor adhesion.

Furthermore, in Examples 5, 8 and 11 where the respective crystalline flake silver powder was blended in an amount of 98% by mass, slight peeling was observed in the adhesion test; however, in other Examples where the respective crystalline silver powder was blended in an amount of 97% by mass or less, no peeling was observed. As for Examples 18 to 25 where the phenoxy resin was used, although the adhesion to the PET film was poor and peeling occurred in Example 25 where the phenoxy resin was used alone, good adhesion was attained in Examples 18 to 24 where the epoxy resin or the acrylic resin was also mixed.

1. An electroconductive composition, comprising:
a crystalline flake silver powder; and
an organic binder,
wherein said crystalline flake silver powder is blended at a ratio of from 90% by mass to 98% by mass with respect to a total solid content of said composition.

2. The electroconductive composition according to claim 1, wherein said crystalline flake silver powder comprises polygonal single particles.

3. The electroconductive composition according to claim 1, wherein said crystalline flake silver powder has an average particle size D₅₀, which is determined by a laser diffraction-scattering particle size distribution analysis, of from 1 μm to 3 μm.

4. A cured article, obtained by
printing or coating the electroconductive composition according to claim 1 on a substrate to form a coating film pattern; and
subsequently drying said coating film pattern at a temperature of lower than 150° C.

5. A cured article, obtained by
printing or coating the electroconductive composition according to claim 2 on a substrate to form a coating film pattern; and
subsequently drying said coating film pattern at a temperature of lower than 150° C.

6. A cured article, obtained by
printing or coating the electroconductive composition according to claim 3 on a substrate to form a coating film pattern; and
subsequently drying said coating film pattern at a temperature of lower than 150° C.
